(19) United States
(12) Patent Application Publication
(10) Pub. No.: US 2026/0269940 A1
(43) Pub. Date: Sep. 10, 2026

(54) ANTI-JAMMING COMMUNICATION LINK FOR REMOTE CONTROLLED VEHICLES USING FREE SPACE OPTICS

(71) Applicant: MaxLinear, Inc., Carlsbad, CA (US)

(72) Inventors: Marcos Martínez Vázquez, Barcelona (ES); Leonard Dauphinee, Costa Mesa, CA (US); Curtis Ling, Carlsbad, CA (US)

(73) Assignee: MaxLinear, Inc., Carlsbad, CA (US)

(21) Appl. No.: 19/561,353

(22) Filed: Mar. 9, 2026

Related U.S. Application Data
(60) Provisional application No. 63/768,818, filed on Mar. 7, 2025.

(51) Int. Cl. H04B 10/112; H04B 10/40

(52) U.S. Cl. CPC H04B 10/112; H04B 10/40

(57) ABSTRACT

A system may include an aiming device. The aiming device may include a first transceiver and a second transceiver. The first transceiver may communicate with a remote controlled vehicle (RCV) using free space optics (FSO). The second transceiver may communicate with a controller device using a communication link. The aiming device may direct an FSO communication signal to a first reception cone of the RCV.

### RELATED APPLICATION

This application claims the benefit of U.S. Provisional Application No. 63/768,818, filed Mar. 7, 2025, the disclosure of which is incorporated herein by reference in its entirety for all purposes.

### FIELD

The examples discussed in the present disclosure are related to anti-jamming communication links for remote controlled vehicles using free space optics.

### BACKGROUND

Unless otherwise indicated herein, the materials described herein are not prior art to the claims in the present application and are not admitted to be prior art by inclusion in this section.

A remotely controlled vehicle (RCV), may be any machine that may be operated and navigated from a distance using a Remote Control Device (RCD) connected to the vehicle through a communication link (radio frequency wireless link or wired connection). This technology allows the user to direct the movement and actions of the vehicle without being physically present in or on it. Remotely controlled vehicles may range from small, hobbyist models such as cars, boats, and drones, to more sophisticated applications like civil and military drones, underwater exploration devices, and space rovers.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a system may include an aiming device. The aiming device may include a first transceiver and a second transceiver. The first transceiver may communicate with a remote controlled vehicle (RCV) using free space optics (FSO). The second transceiver may communicate with a controller device using a communication link. The aiming device may direct a first FSO communication signal to a first reception cone of the RCV.

In some examples, a device may include an RCV including a transceiver that may communicate with a first aiming device using FSO, in which the RCV may receive a first FSO communication signal from the first aiming device in a first reception cone of the RCV.

In some examples, a method may include receiving, at an aiming device, user input from a controller device; generating, at the aiming device, a first FSO communication signal; and directing, using the aiming device, the first FSO communication signal to a reception cone of an RCV.

In some examples, a method may include receiving, at an RCV, a first FSO communication signal from a first aiming device; receiving, at the RCV, a second FSO communication signal from a second aiming device; and performing, at the RCV, an action based on the first FSO communication signal and the second FSO communication signal.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates a block diagram of an example system to control a remotely controlled vehicle.

FIG. 2 illustrates a block diagram of an example system to jam a remotely controlled vehicle.

FIG. 3 illustrates a block diagram of an example system using free space optics.

FIG. 4A illustrates a block diagram of an example system including multiple aiming devices.

FIG. 4B illustrates a block diagram of an example system including an aiming device using multiple wavelengths.

FIG. 5 illustrates a process flow of an aiming device.

FIG. 6 illustrates a process flow of a remote controlled vehicle.

FIG. 7A illustrates a block diagram of an example system for free space optics.

FIG. 7B illustrates a block diagram of an example system for free space optics.

FIG. 8 illustrates a block diagram of an example system that may be used with free space optics.

FIG. 9 illustrates a diagrammatic representation of a machine in the example form of a computing device within which a set of instructions, for causing the machine to perform any one or more of the methods discussed herein, may be executed.

### DESCRIPTION

Remotely controlled vehicles (RCV) utilize radio waves, infrared signals, and/or other communication methods to transmit commands from the remote control to the vehicle, enabling precise control over speed, direction, and various functions.

Since the majority of RCV use wireless radio links to connect the RCV and the remote control device (RCD), jamming may occur for remotely controlled devices, as it disrupts the communication link between the controller and the vehicle, rendering the device uncontrollable. This interference may be intentional, such as in military or security scenarios where adversaries attempt to disable drones or other remote vehicles, or unintentional, caused by overlapping signals from other devices operating on similar frequencies. Jamming may lead to a complete loss of control, resulting in dangerous situations, e.g., in applications like drones in crowded areas, unmanned military operations, or industrial robots. The severity of jamming problems is heightened as the reliance on remote devices increases, leading to the development of more robust anti-jamming technologies and frequency management strategies to ensure uninterrupted and safe operation.

Free Space Optics (FSO) is a communication technology that transmits data using light through the air, rather than through mediums like fiber optic cables. FSO systems utilize lasers, LEDs and other optical systems to create a high-speed, point-to-point visible light or infrared link between two locations, covering distances that may range from a few centimeters to several kilometers. Operating in the visible and infrared spectrum, FSO provides a line-of-sight connection capable of achieving data transfer rates comparable to, or even exceeding, those of fiber optics. The use of highly directional optical signals and the vast range of possible wavelengths available as carrier frequencies make FSO communication difficult to jam, enhancing its security and reliability, e.g., in sensitive applications.

Examples of the present disclosure will be explained with reference to the accompanying drawings.

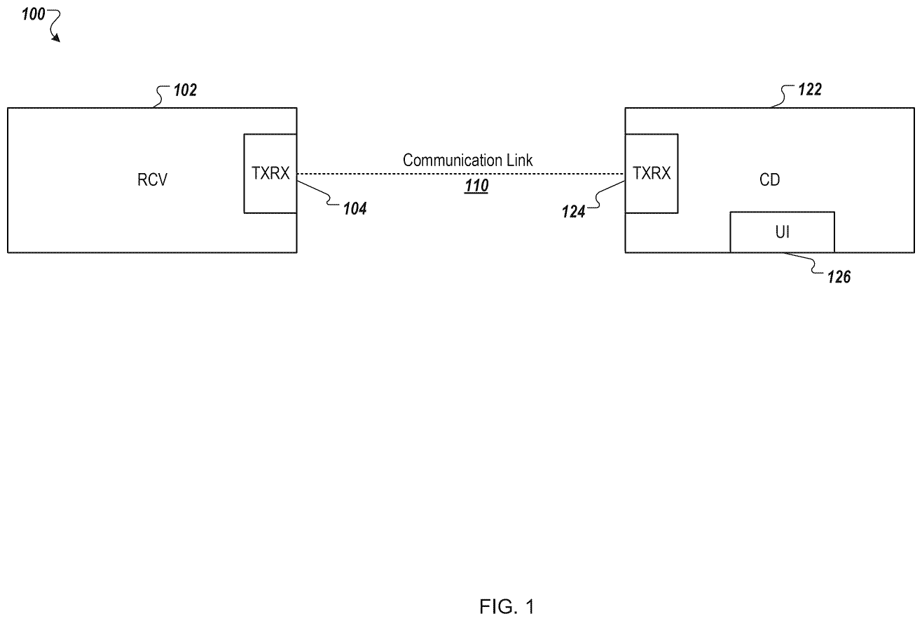

In some examples, FIG. 1 illustrates a system 100 to control an RCV 102. The system 100 may include an RCV 102 (e.g., a drone). The RCV 102 may include a transceiver (TxRx) 104. The TxRx 104 may be a device that may combine a transmitter and a receiver within a unit to send and receive data and/or signals over a communication channel. The TxRx 104 facilitates two-way communication by converting electrical signals into a form suitable for transmission, such as radio waves, light, or infrared, and converting received signals back into electrical form for processing.

The RCV 102 may communicate with a controller device (CD) 122 using a communication link 110. The communication link 110 may be a connection and/or pathway that may facilitate data and/or signals to be transmitted between two or more devices or systems. This communication link 110 may be established using various mediums, such as wired connections (e.g., cables or fiber optics) or wireless channels (e.g., radio waves, microwaves, or light beams). The quality and reliability of a communication link 110 may be influenced by factors like bandwidth, signal strength, and/or potential interference, which may impact the efficiency of the communication process.

The CD 122 may be a device that may include components to remotely control an RCV 102. The CD 122 may include a TxRx 124 that may communicate to the RCV 102 and a user interface (UI) 126 to allow a user to monitor and/or control the movements of the RCV 102.

The UI 126 may facilitate interaction between a human operator and the system 100. The UI 126 may take various forms, including physical controls like buttons, switches, and/or joysticks, as well as digital interfaces such as touchscreens and voice recognition systems. The purpose of the UI 126 is to provide a user-friendly way for humans to control, monitor, and receive feedback from the system, translating human input into machine commands and displaying machine status or output to the user.

Modifications, additions, or omissions may be made to the components of FIG. 1 without departing from the scope of the present disclosure.

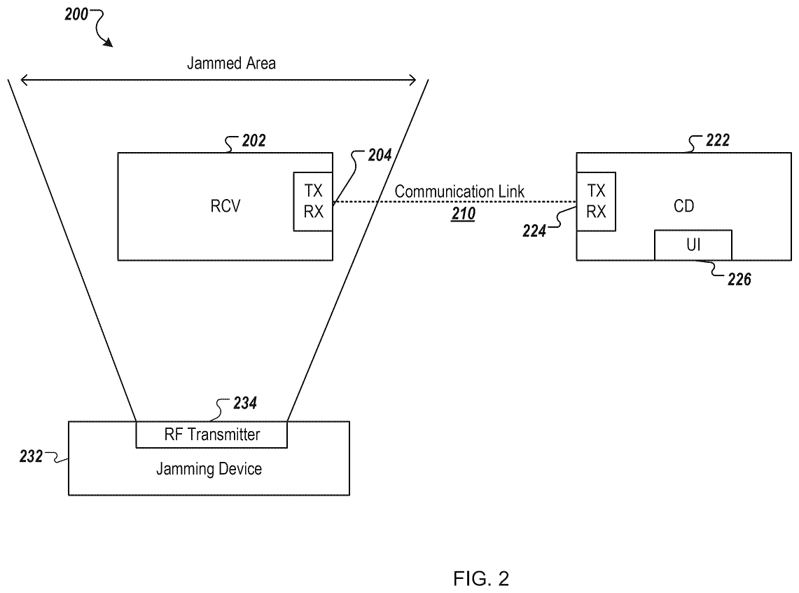

As illustrated in the system 200 in FIG. 2, the communication link 210 between an RCV 202 and a CD 222 may be jammed. Jamming an RCV 202 may involve deliberately disrupting the communication link 210 between the RCV 202 (e.g., a drone) and the CD 222, effectively rendering the RCV 202 uncontrollable. The communication link 210 between the TxRx 204 and the TxRx 224 may be disrupted so that the UI 226 may not control the RCV 202. This process may occur using several operations including: (1) identifying a frequency, (2) deploying a jamming device, and/or (3) disrupting control signals.

First, an RCV 202 (e.g., drone) may operate on specific frequencies (e.g. Wi-Fi frequencies, such as 2.4 GHz or 5.8 GHz) for control signals. One operation in jamming an RCV 202 (e.g., drone) may be to identify the frequency band used for communication.

Second, a jamming device 232, also known as a jammer, may be used to emit signals on the same frequency as the RCV's 202 communication. The jamming device 232 may flood the targeted frequency band with noise or interference, overwhelming the legitimate signals from the RCV's 202 (e.g., drone's) CD 222. The jamming device may include an RF transmitter 234 that may be used to overwhelm the legitimate signals from the RCV's 202 (e.g., drone's) CD 222.

Third, by jamming the control signals, the connection between the RCV 202 (e.g., drone) and its CD 222 may be severed. This severing of the connection between the RCV (e.g., drone) 202 and its CD 222 may cause the RCV 202 (e.g., drone) to e.g., hover in place, attempt a return-to-home function, or in some cases, crash if it loses the connection.

Jamming an RCV 202 may use equipment and knowledge of the specific frequencies that the RCV 202 uses. The jamming device 232 may include an RF transmitter 234 that may inject strong interference in a specific area (directional transmission). Since reception of RF signals by antennas in the RCV 202 is not directional, the reception of the controlling signals from the CD 222 may be blocked.

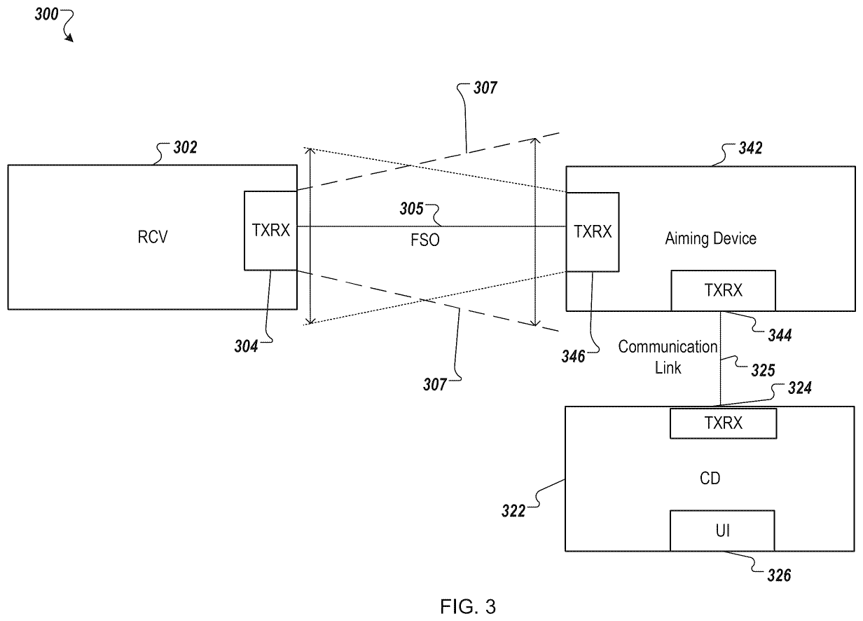

As illustrated in the system 300 in FIG. 3, FSO transmissions may be used to provide resilience against jamming. There are a few factors that facilitate this resilience against jamming.

First, FSO communication signals may be directional and may be directed to the RCV 302 directly. The signals incoming into the reception cone 307 of the RCV 302 may be accepted in the RCV 302. When a jamming signal is not received from a specific direction, the jamming signal may not jam the RCV 302 operated through FSO. Because of the directionality of the signals incoming into the reception cone 307 of the RCV 302, the CD 322 may “aim” the TxRx 346 towards the TxRx 304 of RCV 302. The CD 322 may include two subsystems, the CD 322 and the aiming device 342 connected through a communication link 325 (e.g., a wired or wireless high-speed communication link).

Second, resilience against jamming may be facilitated by a higher range of operating frequency and bandwidth. FSO systems may use a large number of frequencies over a large bandwidth. The operating frequency range may range from several gigahertz (GHz) to up to 500 terahertz (THz). In some examples, the operating frequency range may range from about 187 THz to about 430 THz. The operating frequency may be about 193 THz, 229 THz, or 353 THz. In some examples, wavelengths ranging from 700 nm to about 1600 nm may be used. In some examples, wavelengths ranging from about 800 nm to about 980 nm may be used. The wavelength may be e.g., 700 nm, 800 nm, 850 nm, 980 nm, 1310 nm, 1315 nm, 1550 nm, or 1600 nm. Unlike traditional radio frequency (RF) communication systems, which may be limited to specific frequency bands, FSO systems may operate in the optical spectrum, including visible light, infrared, and/or near-infrared wavelengths. The bandwidth may depend on the specific FSO system design, including the type of laser or light source used, the modulation technique, and/or the distance of the communication link.

The distance over which the RCV 302 may be controlled by the CD 322 may depend on several factors. For example, the distance may depend on the optical front end and the optical technology used. For visible light, the distance may be about 100 meters with throughput of up to about several hundreds of Mbps. For infrared light, the distance may be up to about several hundreds of meters with up to about several Gbps of throughput. For lasers, the distance may be up to a few kilometers. The distance may also be limited by the injected power in the optical frontend.

A system 300 may include an aiming device 342. The aiming device 342 may include a first TxRx 346 that may communicate with an RCV 302 using FSO. The aiming device 342 may include a second TxRx 344 that may communicate with a CD 322 using a communication link 325. The aiming device 342 may direct an FSO communication signal 305 to a reception cone 307 of the RCV 302. The FSO communication signal 305 may have an operating frequency in a frequency range of from about 1 GHz to about 500 THz.

The reception cone 307 may be a conical shape having various angles. In one example, the angle of the reception cone 307 may range from 0 to 360 degrees. In some examples, the angle of the reception cone may be from 0 to 90 degrees. In other examples, the angle of the reception cone may be from 25 to 65 degrees. In other examples, the angle of the reception cone may be from 35 to 55 degrees. In other examples, the angle of the reception cone 307 may be selected based on a trade-off between an aperture window and jamming protection. A smaller angle for the reception cone 307 may provide for enhanced jamming protection. The angle may be selected based on the distance between the RCV 302 and the aiming device 342.

The system 300 may include an RCV 302. The RCV 302 may include a TxRx 304 that may communicate with a first aiming device 342 using FSO. The RCV 302 may receive a first FSO communication signal 305 from the first aiming device 342 in a reception cone 307 of the RCV 302. The RCV 302 may have a TxRx 304 that may receive the first FSO communication signal 305 from the TxRx 346 of the aiming device 342.

The system may include a CD 322. The CD 322 may include a transceiver 324 that may communicate with a TxRx 344 of the aiming device 342 via communication link 325. The CD may have a user interface 326 that may be operated by a user.

The TxRx 304 of the RCV 302 may track the TxRx 346 of the aiming device 342 and the TxRx 346 of the aiming device 342 may track the TxRx 304 of the RCV 302. That is, the aiming device 342 may aim at the RCV 302 and the RCV 302 may aim at the aiming device 342. Therefore, the two sides of the communication link (e.g., RCV 302 and aiming device 342) may include a tracking device. A selected angle between the aiming device 342 and the RCV 302 may be maintained when the RCV 302 tracks the aiming device 342 and the aiming device 342 tracks the RCV 302.

The tracking may be implemented using a mechanical device, a beamforming process, or a combination thereof. For example, when using a mechanical device for tracking, gyroscopes may be used to maintain the alignment of the laser (e.g., of the RCV 302 or the aiming device 342) and the photodiode (e.g., of the aiming device 342 or the RCV 302). In addition or alternatively, a gimbal mount may be used to maintain the alignment of the laser and the photodiode. As a result, the RCV's 302 range may be enhanced and the immunity to jamming of the system 300 may be enhanced.

In addition or alternatively, beamforming may be used to implement tracking. An array of photodiodes and/or lasers may be used with active optics to maintain the angle between the aiming device 342 (e.g., TxRx 346) and the RCV 302 (e.g., TxRx 304).

In addition or alternatively, the aiming device 342 may facilitate one or more of frequency hopping (or wavelength hopping) or polarization hopping for the first FSO communication signal 305. Hopping between frequencies (or wavelengths) and/or polarization may increase robustness against jamming.

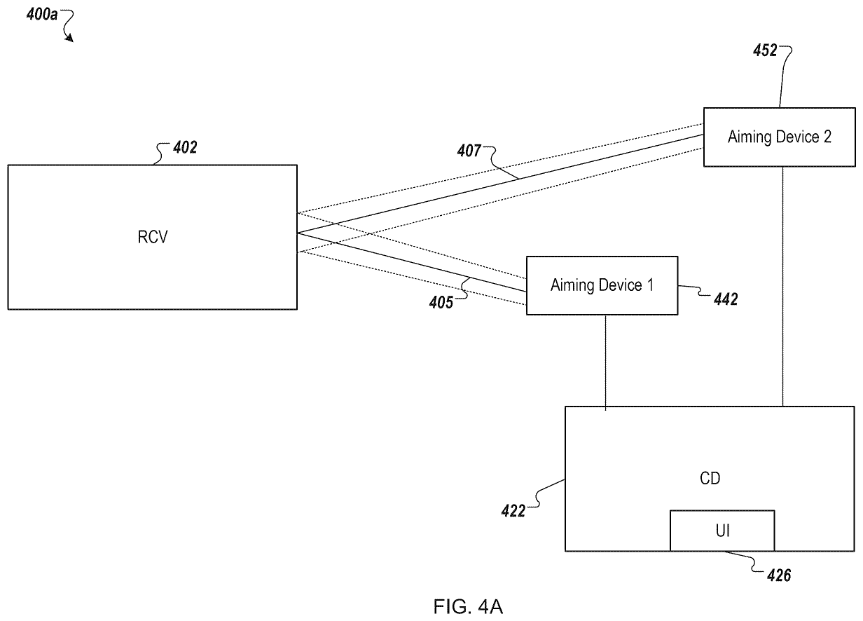

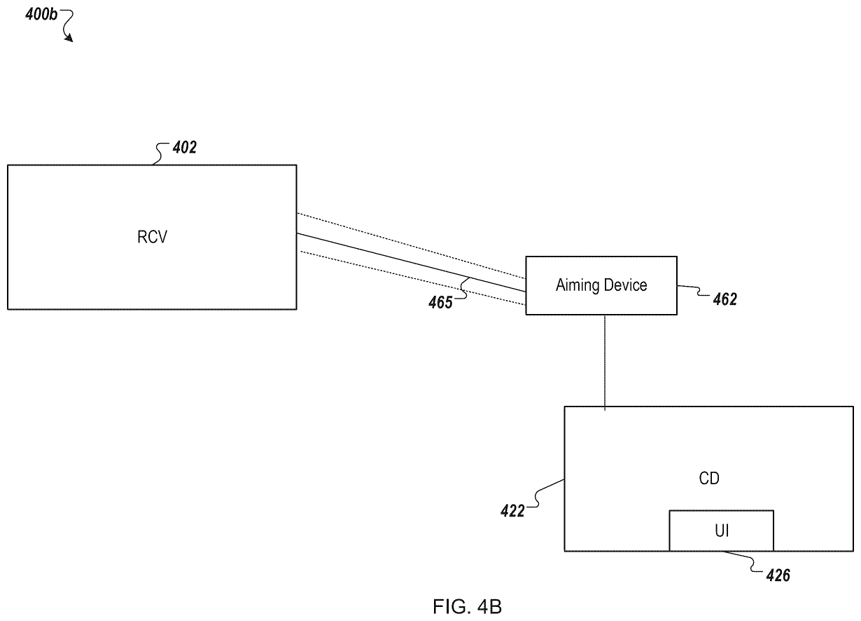

As illustrated in the system 400a in FIG. 4A, multiple aiming devices may be used. The use of FSO technology and the directivity of the FSO link may use additional aiming devices to enhance the maneuverability of the RCV 402. One or more aiming devices 442, 452 may be positioned at different angles. By employing multi-channel techniques, these aiming devices 442, 452 allow the RCV 402 to receive multiple copies of the information (e.g., data and/or control information), thereby enhancing the reliability and/or flexibility of the communication link. In the RCV 402 to AD device, broader transmissions may be used to communicate with one or more aiming devices 442, 452 at the same time. The CD 422 may have a user interface 426 that may be operated by a user.

The first aiming device 442 may include a first transceiver that may communicate with the CD 422 and a second transceiver that may communicate with the RCV 402. The second transceiver may communicate with the RCV using FSO in which the communication signal may be directed to a reception cone of the RCV 402.

A second aiming device 452 may include a third transceiver that may communicate with the controller device and a fourth transceiver that may communicate with the RCV 402 using FSO. The second aiming device may direct an FSO communication signal to a reception cone of the RCV 402.

The one or more aiming devices 442, 452 may be positioned at different angles. The first aiming device 442 may be positioned at a first angle relative to the reception cone of the RCV 402 and the second aiming device 452 may be positioned at a second angle relative to the reception cone of the RCV 402.

The one or more aiming devices 442, 452 may send multiple copies of data to enhance the robustness and reliability of the transmission. The first aiming device 442 may send a first copy of data on a first channel and the second aiming device 452 may send a second copy of data on a second channel.

The RCV 402 may receive a first FSO communication signal 405 from a first aiming device 442 in a reception cone of the RCV 402. The RCV 402 may receive a second FSO communication signal 407 from a second aiming device 452 in a reception cone of the RCV 402. The RCV may receive the first FSO communication signal 405 from a first angle relative to the reception cone of the RCV 402 and receive the second FSO communication signal 407 from a second angle relative to the reception cone of the RCV 402. The RCV 402 may communicate with the first aiming device 442 and the second aiming device 452 using one transmission.

The reception cone of the RCV 402 may be one or more reception cones. For example, the first aiming device 442 may send the first FSO communication signal 405 at a first angle relative to a first reception cone of the RCV 402 and the second aiming device 452 may send the FSO communication signal 407 at a second angle relative to a second reception cone of the RCV 402 in which the first reception cone and the second reception cone may be independent of the other reception cone. The RCV 402 may include multiple reception cones that may be associated with multiple aiming devices.

One or more drones may communicate with one or more aiming devices to enhance the robustness of the communication. For example, a relay and/or mesh network may be used to allow one or more drones to communicate with one or more aiming devices.

When more than one aiming device is used, tracking may be implemented. For example, the RCV 402 may track the first aiming device 442 and the second aiming device 452, and the first aiming device 442 and/or the second aiming device 452 may track the RCV 402. The tracking may be effectuated using a mechanical device, a beamforming process, or a combination thereof as previously discussed.

The second aiming device 452 may be located in a second RCV. The second RCV may allow for movement of the second aiming device with respect to the RCV 402. In some examples, the RCV 204 and the second RCV may be aligned in a formation to allow for communication between the RCV 204 and the second RCV.

Although two aiming devices are illustrated in FIG. 4A, any suitable number of aiming devices may be used. Increasing the number of aiming devices may enhance the security against jamming.

As illustrated in the system 400b in FIG. 4B, an aiming device 462 may communicate using multiple wavelengths that may be directed to the same cone of the RCV 402. The aiming device 462 may include a transceiver that may communicate with CD 422 which may have a user interface 426 that may be operated by a user. The aiming device 462 may send one or more FSO communication signals 465 in which the one or more FSO communication signals 465 may include a first wavelength that may be directed to a reception cone of the RCV 402 and a second wavelength that may be directed to the reception cone of the RCV 402. The first wavelength and the second wavelength may be different wavelengths.

Using different wavelengths may prevent jamming. In addition or alternatively, using different wavelengths may facilitate robust communication in different environmental conditions (e.g., such as in rain). In addition or alternatively, using different wavelengths may provide for failover. For example, a first wavelength may be used to actively communicate control and/or data while a second wavelength may be passively connected in the case of failure of the first wavelength. By using two different wavelengths, the latency for failover may be reduced.

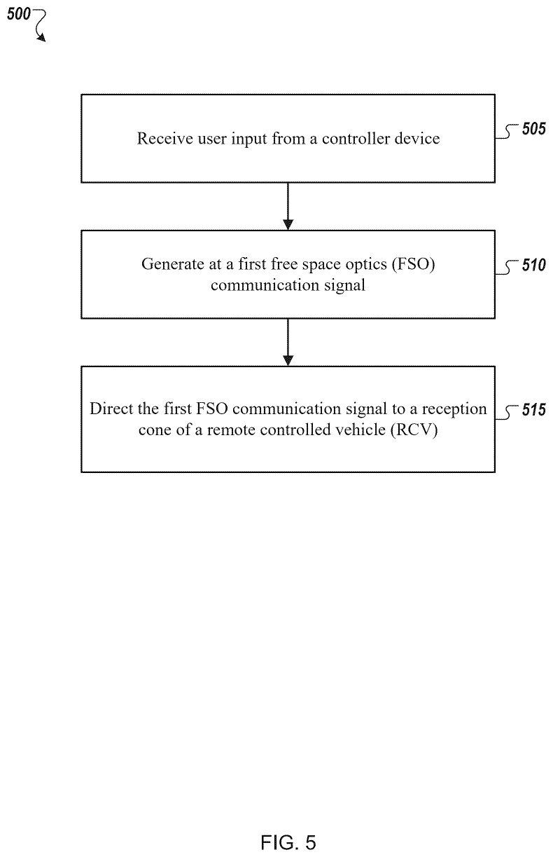

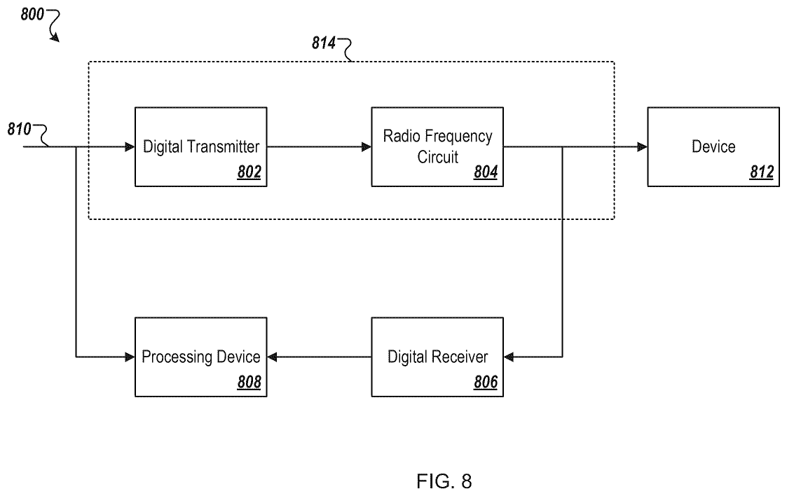

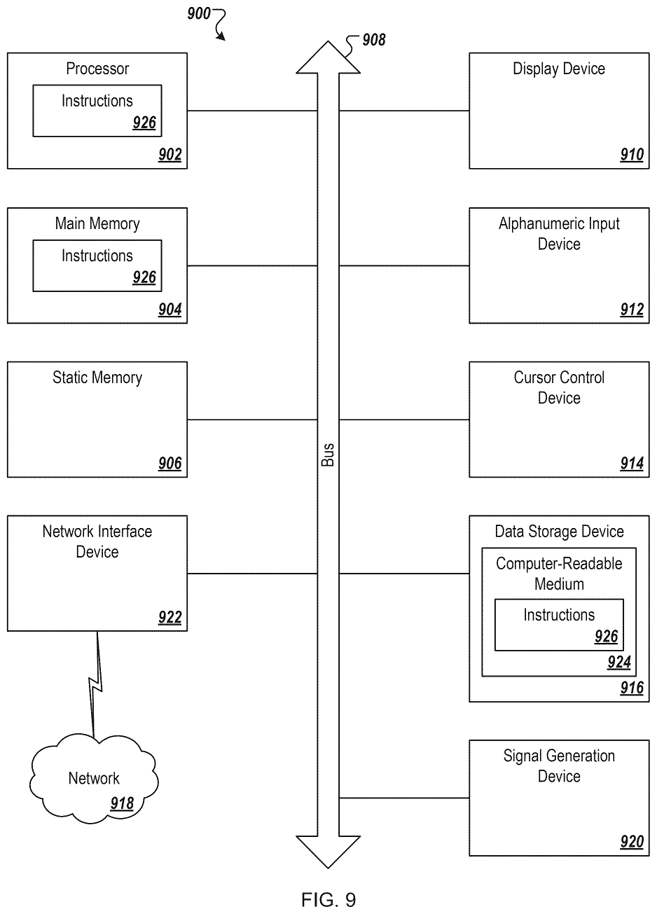

FIG. 5 illustrates a process flow of an example method 500 of an aiming device, in accordance with at least one example described in the present disclosure. The method 500 may be arranged in accordance with at least one example described in the present disclosure. The method 500 may be performed by processing logic that may include hardware (circuitry, dedicated logic, etc.), software (such as is run on a computer system or a dedicated machine), or a combination of both, which processing logic may be included in the processing device 902 of FIG. 9, the communication system 800 of FIG. 8, or another device, combination of devices, or systems.

The method 500 may begin at block 505 where the processing logic may receive, at an aiming device, user input from a controller device. At block 510, the processing logic may generate, at the aiming device, a first FSO communication signal. At block 515, the processing logic may direct, using the aiming device, the first FSO communication signal to a reception cone of an RCV.

The processing logic may direct, using the aiming device, the FSO communication signal from a first angle relative to the reception cone of the RCV. The processing logic may receive, at a second aiming device, user input from the controller device. The processing logic may generate, at the second aiming device, a second FSO communication signal. The processing logic may direct, using the second aiming device, the second FSO communication signal to the reception cone of the RCV. The processing logic may direct, using the aiming device, the second FSO communication signal from a second angle relative to the reception cone of the RCV. The first FSO communication signal and/or the second FSO communication signal may have an operating frequency in a frequency range of from about 1 GHz to about 1 THz. The first FSO communication signal may have a first wavelength, and the processing logic may further direct an additional FSO communication signal to the reception cone of the RCV, in which the additional FSO communication signal may have a second wavelength.

Modifications, additions, or omissions may be made to the method 500 without departing from the scope of the present disclosure. For example, in some examples, the method 500 may include any number of other components that may not be explicitly illustrated or described.

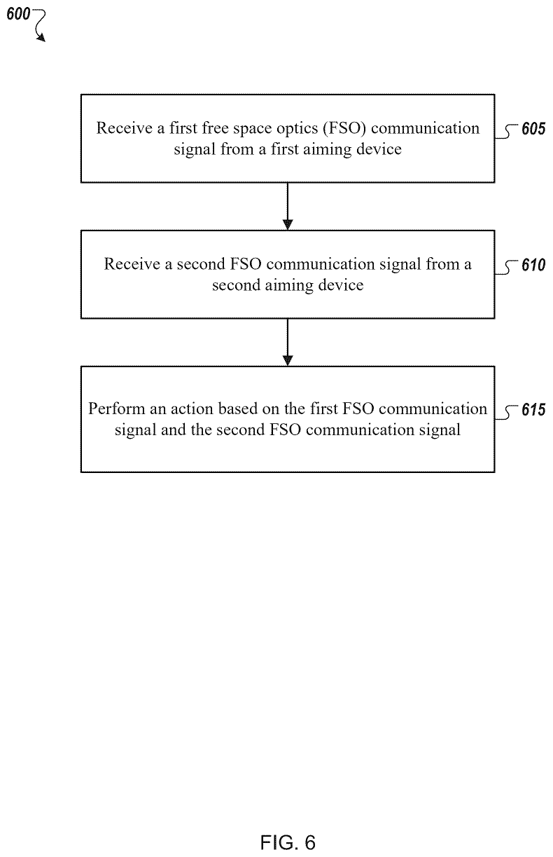

FIG. 6 illustrates a process flow of an example method 600 of an RCV, in accordance with at least one example described in the present disclosure. The method 600 may be arranged in accordance with at least one example described in the present disclosure.

The method 600 may be performed by processing logic that may include hardware (circuitry, dedicated logic, etc.), software (such as is run on a computer system or a dedicated machine), or a combination of both, which processing logic may be included in the processing device 902 of FIG. 9, the communication system 800 of FIG. 8, or another device, combination of devices, or systems.

The method 600 may begin at block 605 where the processing logic may receive, at an RCV, a first FSO communication signal from a first aiming device. At block 610, the processing logic may receive, at the RCV, a second FSO communication signal from a second aiming device. At block 615, the processing logic may perform, at the RCV, an action based on the first FSO communication signal and the second FSO communication signal.

The processing logic may receive, at the RCV, the first FSO communication signal and the second FSO communication signal, in a reception cone of the RCV. The processing logic may receive, at the RCV, the first FSO communication signal at a first angle relative to a reception cone of the RCV. The processing logic may receive, at the RCV, the second FSO communication signal at a second angle relative to the reception cone of the RCV. The processing logic may communicate, at the RCV, with the first aiming device and the second aiming device using one transmission. The first FSO communication signal and/or the second FSO communication signal may have an operating frequency in a frequency range of from about 1 GHz to about 1 THz. The processing logic may track, at the RCV, the first aiming device.

Modifications, additions, or omissions may be made to the method 600 without departing from the scope of the present disclosure. For example, in some examples, the method 600 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

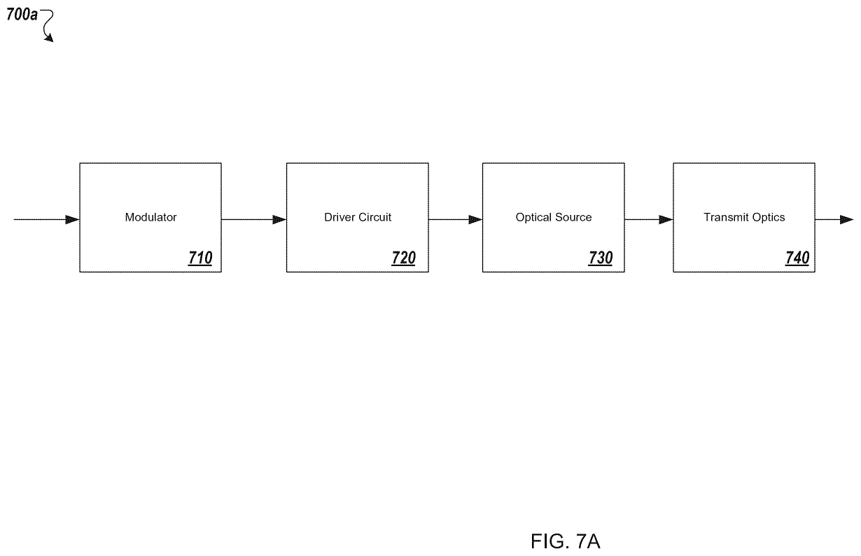

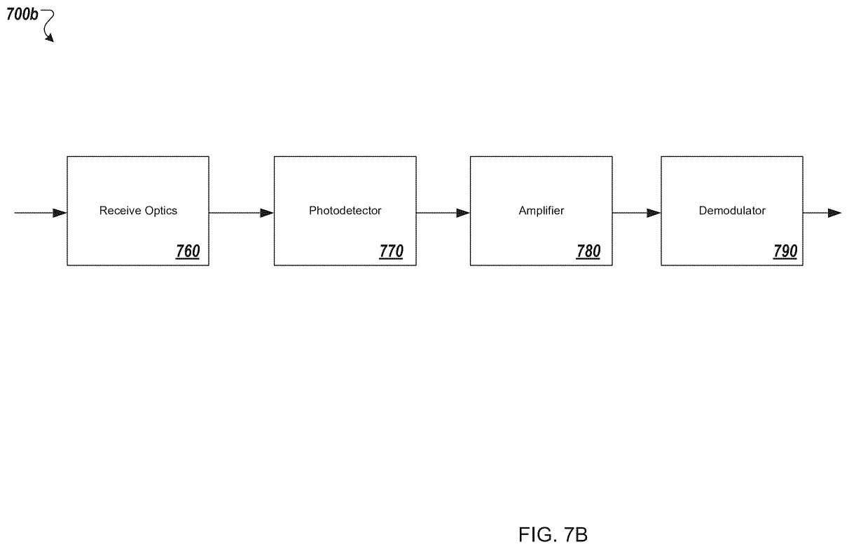

FIG. 7A illustrates a block diagram of an example communication system 700a operable for transmission using free space optics in accordance with at least one example described in the present disclosure. The communication system 700a may include a modulator 710, a driver circuit 720, an optical source 730, and/or transmit optics 740.

The modulator 710 may receive a signal. The modulator may modulate the signal using various techniques including one or more of amplitude modulation, frequency modulation, phase modulation, and/or polarization modulation. Some examples of modulation techniques include on-off keying non-return to zero (OOK-NRZ), on-off keying return to zero (OOK-RZ), pulse position modulation (PPM), multi-pulse position modulation (MPPM), differential pulse position modulation (DPPM), overlapping pulse position modulation (OPPM), subcarrier intensity modulation (SIM), or the like.

The modulated signal may be directed to a driver circuit 720. The driver circuit 720 may be a circuit that may e.g., control the intensity of an optical source 730 by varying current flowing through the optical source 730. The optical source 730 may be a light emitting diode (LED) or a laser diode. The transmit optics 740 may direct the optical source 730 through a medium.

FIG. 7B illustrates a block diagram of an example communication system 700b operable to receive free space optics in accordance with at least one example described in the present disclosure. The communication system 700b may include receive optics 760, a photodetector 770, an amplifier 780, and/or a demodulator 790.

The receive optics 760 may receive an optical signal and direct the optical signal to a photodetector 770. The photodetector 770 may convert the light source into an electrical signal. The electrical signal may be amplified by an amplifier 780. The demodulator may demodulate the amplified signal to generate a demodulated signal.

FIG. 8 illustrates a block diagram of an example communication system 800 operable for use with free space optics, in accordance with at least one example described in the present disclosure. The communication system 800 may include a digital transmitter 802, a radio frequency circuit 804, a device 812, a digital receiver 806, and a processing device 808. The digital receiver 806 and the processing device 808 may receive a baseband signal via connection 810. A transceiver 814 may include the digital transmitter 802 and the radio frequency circuit 804. Alternatively or in addition, the transceiver 814 may include the digital receiver 806.

In some examples, the communication system 800 may include a system of devices that may communicate with one another via a wired or wireline connection. For example, a wired connection in the communication system 800 may include one or more Ethernet cables, one or more fiber-optic cables, and/or other similar wired communication mediums. Alternatively, or additionally, the communication system 800 may include a system of devices that may communicate via one or more wireless connections. For example, the communication system 800 may include one or more devices that may transmit and/or receive radio waves, microwaves, ultrasonic waves, optical waves, electromagnetic induction, and/or similar wireless communications. Alternatively, or additionally, the communication system 800 may include combinations of wireless and/or wired connections. In these and other examples, the communication system 800 may include one or more devices that may obtain a baseband signal, perform one or more operations to the baseband signal to generate a modified baseband signal, and transmit the modified baseband signal, such as to one or more loads. In these and other examples, the communication system 800 may include one or more devices that may obtain radio waves, microwaves, ultrasonic waves, optical waves, electromagnetic induction, and/or similar wireless communications to generate a baseband signal by performing one or more operations.

In some examples, the communication system 800 may include one or more communication channels that may communicatively couple systems and/or devices included in the communication system 800. For example, the transceiver 814 may be communicatively coupled to the device 812.

In some examples, the transceiver 814 may obtain a baseband signal. For example, as described herein, the transceiver 814 may generate a baseband signal and/or receive a baseband signal from another device. In some examples, the transceiver 814 may transmit the baseband signal. For example, upon obtaining the baseband signal, the transceiver 814 may transmit the baseband signal to a separate device, such as the device 812. Alternatively, or additionally, the transceiver 814 may modify, condition, and/or transform the baseband signal in advance of transmitting the baseband signal. For example, the transceiver 814 may include a quadrature up-converter and/or a digital to analog converter (DAC) that may modify the baseband signal. Alternatively, or additionally, the transceiver 814 may include a direct radio frequency (RF) sampling converter that may modify the baseband signal. In some examples, the transceiver 814 may receive a signal (e.g., an RF signal, an optical signal, or the like) from a device. The transceiver may include an optical subsystem that may convert the optical signal to an electrical signal. The electrical signal may be an analog signal. The analog signal may be converted to a digital signal using an analog to digital converter (ADC).

In some examples, the digital transmitter 802 may obtain a baseband signal via connection 810. In some examples, the digital transmitter 802 may up-convert the baseband signal. For example, the digital transmitter 802 may include a quadrature up-converter to apply to the baseband signal. In some examples, the digital transmitter 802 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 802.

In some examples, the radio frequency circuit 804 may obtain a signal (e.g., an RF signal, an optical signal, or the like) from a device 812. In some examples, the radio frequency circuit 804 may convert the analog signal to a digital signal. In some examples, the ADC architecture may be a separate element from the digital receiver 806. The digital receiver 806 may down-convert the digital signal to a baseband signal. The digital receiver may include a quadrature down-converter to generate the baseband signal.

In some examples, the transceiver 814 may include one or more subcomponents that may be used in preparing the baseband signal and/or transmitting the baseband signal. For example, the transceiver 814 may include an RF front end (e.g., in a wireless environment) which may include a power amplifier (PA), a digital transmitter (e.g., 802), a digital front end, a device that may implement Institute of Electrical and Electronics Engineers (IEEE) 1588v2, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 804) of the transceiver 814 may be synchronized with the resource controller via the S-plane device, which may contribute to high-accuracy timing with respect to a reference clock.

In some examples, the transceiver 814 may obtain the baseband signal for transmission. For example, the transceiver 814 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 814 may generate a baseband signal for transmission. In these and other examples, the transceiver 814 may transmit the baseband signal to another device, such as the device 812.

In some examples, the device 812 may receive a transmission from the transceiver 814. For example, the transceiver 814 may transmit a baseband signal to the device 812. In other examples, the device 812 may transmit a transmission to the transceiver 814. For example, the transceiver 814 may receive a transmission from the device 812.

In some examples, the radio frequency circuit 804 may transmit the digital signal received from the digital transmitter 802. In some examples, the radio frequency circuit 804 may transmit the digital signal to the device 812 and/or the digital receiver 806. In some examples, the digital receiver 806 may receive a digital signal from the RF circuit and/or send a digital signal to the processing device 808.

In some examples, the processing device 808 may be a standalone device or system, as illustrated. Alternatively, or additionally, the processing device 808 may be a component of another device and/or system. For example, in some examples, the processing device 808 may be included in the transceiver 814. In instances in which the processing device 808 is a standalone device or system, the processing device 808 may communicate with additional devices and/or systems remote from the processing device 808, such as the transceiver 814 and/or the device 812. For example, the processing device 808 may send and/or receive transmissions from the transceiver 814 and/or the device 812. In some examples, the processing device 808 may be combined with other elements of the communication system 800.

FIG. 9 illustrates a diagrammatic representation of a machine in the example form of a computing device 900 within which a set of instructions, for causing the machine to perform any one or more of the methods discussed herein, may be executed. The computing device 900 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 900 includes a processing device (e.g., a processor) 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 916, which communicate with each other via a bus 908.

Processing device 902 represents one or more general-purpose processing devices such as a microprocessor, central processing unit, or the like. More particularly, the processing device 902 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also include one or more special-purpose processing devices such as an application specific integrated circuit (ASIC), a field programmable gate array (FPGA), a digital signal processor (DSP), network processor, or the like. The processing device 902 is configured to execute instructions 926 for performing the operations and steps discussed herein.

The computing device 900 may further include a network interface device 922 which may communicate with a network 918. The computing device 900 also may include a display device 910 (e.g., a liquid crystal display (LCD) or a cathode ray tube (CRT)), an alphanumeric input device 912 (e.g., a keyboard), a cursor control device 914 (e.g., a mouse) and a signal generation device 920 (e.g., a speaker). In at least one example, the display device 910, the alphanumeric input device 912, and the cursor control device 914 may be combined into a single component or device (e.g., an LCD touch screen).

The data storage device 916 may include a computer-readable storage medium 924 on which is stored one or more sets of instructions 926 embodying any one or more of the methods or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 918 via the network interface device 922.

While the computer-readable storage medium 924 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A system, comprising:
an aiming device comprising:
a first transceiver operable to communicate with a remote controlled vehicle (RCV) using free space optics (FSO); and
a second transceiver operable to communicate with a controller device using a communication link,
wherein the aiming device is operable to direct a first FSO communication signal to a first reception cone of the RCV.

2. The system of claim 1, wherein the first FSO communication signal is communicated using a first wavelength and the aiming device is operable to direct an additional FSO communication signal to the first reception cone of the RCV using a second wavelength.

3. The system of claim 1, further comprising a second aiming device comprising a third transceiver operable to communicate with the controller device and a fourth transceiver operable to communicate with the RCV using FSO, wherein the second aiming device is operable to direct a second FSO communication signal to a second reception cone of the RCV.

4. The system of claim 3, wherein:
the first aiming device is positioned at a first angle relative to the first reception cone of the RCV and the second aiming device is positioned at a second angle relative to the second reception cone of the RCV; or
the first aiming device is operable to send a first copy of data on a first channel and the second aiming device is operable to send a second copy of data on a second channel.

5. The system of claim 3, wherein the second aiming device is located in a second RCV.

6. The system of claim 1, wherein the first FSO communication signal has an operating frequency in a frequency range of from about 1 gigahertz (GHz) to about 500 terahertz (THz).

7. The system of claim 1, wherein the first transceiver is operable to track an RCV transceiver.

8. The system of claim 1, wherein the aiming device is operable to facilitate one or more of frequency hopping or polarization hopping for the first FSO communication signal.

9. A device, comprising:
a remote controlled vehicle (RCV) comprising a transceiver operable to communicate with a first aiming device using free space optics (FSO), wherein the RCV is operable to receive a first FSO communication signal from the first aiming device in a first reception cone of the RCV.

10. The device of claim 9, wherein the first FSO communication signal is communicated using a first wavelength and the first aiming device is operable to direct an additional FSO communication signal to the first reception cone of the RCV using a second wavelength.

11. The device of claim 9, wherein the RCV is operable to receive a second FSO communication signal from a second aiming device in a second reception cone of the RCV.

12. The device of claim 11, wherein the RCV is operable to receive the first FSO communication signal from a first angle relative to the first reception cone of the RCV and receive the second FSO communication signal from a second angle relative to the second reception cone of the RCV.

13. The device of claim 11, wherein the RCV is operable to communicate with the first aiming device and the second aiming device using one transmission.

14. The device of claim 9, wherein the first FSO communication signal has an operating frequency in a frequency range of from about 1 gigahertz (GHz) to about 500 terahertz (THz).

15. The system of claim 9, wherein the transceiver is operable to track the aiming device transceiver.

16. A method comprising:
receiving, at an aiming device, user input from a controller device;
generating, at the aiming device, a first free space optics (FSO) communication signal; and
directing, using the aiming device, the first FSO communication signal to a reception cone of a remote controlled vehicle (RCV).

17. The method of claim 16, wherein the first FSO communication signal has a first wavelength, wherein the method further comprises:
directing an additional FSO communication signal to the reception cone of the RCV, wherein the additional FSO communication signal has a second wavelength.

18. The method of claim 16, further comprising:
directing, using the aiming device, the first FSO communication signal from a first angle relative to the reception cone of the RCV.

19. The method of claim 16, further comprising:
receiving, at a second aiming device, user input from the controller device;
generating, at the second aiming device, a second FSO communication signal; and
directing, using the second aiming device, the second FSO communication signal to the reception cone of the RCV.

20. The method of claim 16, further comprising:
directing, using the aiming device, the second FSO communication signal from a second angle relative to the reception cone of the RCV.
